(19) United States
(12) Patent Application Publication
(10) Pub. No.: US 2006/0258354 A1
(43) Pub. Date: Nov. 16, 2006

(54) Method for restricting mobility in wireless mobile systems

(76) Inventor: Tanveer ul Haq, Lahore (PK)

Correspondence Address: BROWN & MICHAELS, PC;400 M & T BANK BUILDING, 118 NORTH TIOGA ST, ITHACA, NY, 14850, US

(21) Appl. No.: 11/128,555

(22) Filed: May 13, 2005

(51) Int. Cl. H04Q 7/20

(52) U.S. Cl. 455/436

(57) ABSTRACT

A method of restricting mobility in a Wireless Mobile System for Wireless Local Loop applications. Although this method is applicable to all wireless technologies, it provides specific improvements to mobility restriction in CDMA systems. Mobility of a subscriber is restricted to a predefined set of cell (sectors) called the Home-cell Set or Home-sector Set of the subscriber. In CDMA this set consists of PN Offsets of all sectors in which handset is allowed to have service. A subscriber can make or receive calls till the time at least one cell in its Home-cell Set can support its calls. In CDMA systems the handset is allowed to have soft handoff with as many sectors as required till the time at least one of the Home-cells is in the Active Set of pilots for the handset. This method also has an option that allows calls that are setup in a Home-cell to continue beyond the boundaries of the Home-cell Set and it also allows emergency calls to be made from within the no-service cells.

### BACKGROUND OF THE INVENTION

1. Field of the Invention

The invention pertains to the field of wireless communications. More particularly, the invention relates to restriction of mobility in wireless communication systems for Wireless Local Loop applications.

2. Description of Related Art

Wireless cellular systems are designed for full mobility. This is true for all major technologies including AMPS, TDMA, GSM, CDMA, UMTS etc. Full mobile technologies are also used in Wireless Local Loop Systems because of their maturity and cost effectiveness. WLL licenses issued by regulators mostly allow either fixed service or Limited Mobility. Limited Mobility is defined differently by each regulator. In many cases mobility is restricted to a cell site or Base Station, i.e. a subscriber is allowed communication with only one cell-site/Base station and no handoffs (handovers) are allowed. This can be detrimental to the performance of Wireless systems especially those that are based upon CDMA technology. CDMA system performance can seriously degrade if soft handoff feature of CDMA is disabled. This is a problem for WLL operators as to how to restrict mobility in wireless systems while maintaining the Quality of Service (QoS) of their network. The method described here implements restricted mobility without affecting system performance, especially in CDMA systems. In description of this method the word “cell” has the same meaning as it is used in GSM and UMTS. “Cell” means the smallest geographical area in a cellular system that is identified by a User Equipment from a (cell) identification that is broadcast by the Radio Equipment. In some literature and in CDMA systems cell is termed as sector. In CDMA the cell identification transmitted by the radio is the PN Code Offset, while in GSM it is the Cell ID.

Prior art related to mobility restrictions in WLL systems relies on definition of geographical areas within which mobility is allowed. These geographical areas are named Mobility Area (MOA) or Location Area (LA) in GSM and User Zones in CDMA systems. A subscriber is allowed to get service and do handoff with only those cells (sectors) which are within a pre-defined geographical area. At the boundary of the geographical area handoffs or handovers are disallowed. Also in CDMA systems handoffs to cells (sectors) outside the mobility area or user zones are disallowed. This affects the OoS of CDMA networks. It is because CDMA technology uses soft handoff feature not only for mobility but also for managing co-channel interference. Mobility restrictions in current CDMA systems do not allow soft handoff with cells that are outside the boundary of a geographical area. This is detrimental to call quality of CDMA subscribers, especially those that are in the border areas of mobility area or user zones.

The following patents and published patent applications are relevant to the present invention:
Sareela, et al., U.S. Pat. No. 6,301,475 dated 9 Oct., 2001, “Procedure for limiting the mobility area of a terminal device in a wireless local loop.”
Weaver, Jr., et al., U.S. Pat. No. 5,828,661, 27 Oct. 1998, “Method and apparatus for providing a cone of silence in a cellular communication system.”
Oshigiri, Hiroshi, US Published Patent Application No. 2001/0014584, 16 Aug. 2001, “Wireless local loop access network system.”
Takashima, Ken; US Published Patent Application No., 2002/0072380, 13 Jun. 2002, “Mobile communications system using a fixed wireless telephone network.”
Younis, Saeed G., US Published Patent Application No. 20020132650, 19 Sep. 2002, “Method and system for restricting mobility in a wireless local loop.”
Younis, Saeed G., US Published Patent Application No. 20030039360, dated 27 Feb. 2003, “Method and system for restricting mobility using unique encrypted chargers.”

### SUMMARY OF THE INVENTION

The present invention presents a method for restricting mobility in wireless communication systems while maintaining the Quality of Service, especially in CDMA systems. The method of the invention described here makes few distinct changes to the prior art of restricting mobility.
(1) A method is adopted wherein a Home-cell set in developed that is pre-defined for each subscriber. This Home-cell set is composed of cells in which the subscriber is allowed service. In CDMA systems this Home-cell set will consist of PN Offsets of all cells (sectors) in which the subscriber can get service. PN Offset based User Zones is a major contribution of this method in CDMA.
(2) Existing non-CDMA systems do not allow handover to an adjacent Mobility Area (MOA) or Location area (LA) as the handset moves out of its pre-defined mobility area. This method allows, as an option, the continuation of calls that are setup in a Mobility Area where service is allowed to be handed over to an adjacent mobility area, where service is not allowed. This method also allows emergency calls to be setup in areas where normal service is not allowed.
(3) Current CDMA systems allow no handoffs with cells (sectors) that are not within a particular user zone. This is detrimental to system performance. The method of the invention specified here does not put any restrictions on soft handoff in CDMA provided at least one PN Offset from the Home-cell set is part of the Active Set of the handset. This mobility restriction is imposed without limiting soft handoff in any way. Thus, QoS of the CDMA system is not compromised. Soft Handoff is used for countering interference but it is not allowed to impact mobility restrictions.
(4) Previous GSM methods implement cell restrictions at the handset, while CDMA systems implement it at the network. The method described herein allows implementation at the handset or at the network or both.

### BRIEF DESCRIPTION OF THE DRAWING

FIGS. 1a and 1b show cell (sector) and cell-site (base station) diagrams

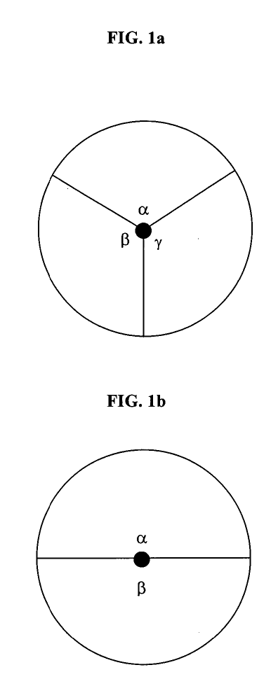

FIG. 2 shows the example of implementation of the method of the present invention for restricting mobility in a Single Cell of a wireless communication system

FIG. 3 illustrates an example of implementing Region Based Mobility Restrictions in a wireless communication system using the method of the present invention.

### DETAILED DESCRIPTION OF THE INVENTION

In the method described here mobility in a wireless system is restricted by associating each subscriber (handset) to one or more cells (sectors) or cell-sites. When the signal received from the associated cell becomes weak in terms of signal strength or signal to noise ratio the handset is disallowed service. The service is also disconnected when the quality of the link either on the forward or reverse link deteriorates below a pre-defined level for the associated cell or when the capacity of the associated cell does not allow new connections. Service termination could be initiated either by the handset (if the handset is so programmed) or by the network. This method can be used to restrict mobility within a cell (sector), within a cell-site (base station), within a cluster of cell-sites or within a defined area/zone.

Definitions:
Cell: In the text of this patent disclosure the words “cell” and “sector” mean the same and are used interchangeably. Similarly the word “cell-site” and “base station” have similar meanings.
Subscriber Terminal: The words handset, subscriber handset and user equipment are used to mean the subscriber terminal that is provided service by the network.
Active Set: is the set of cells with which the handset is communicating at any given time. As examples, in GSM and TDMA systems the Active Set consists of only one cell, while in CDMA the active set may have 1 or more cells because of soft handoff with multiple cells.

Soft Handoff: Soft Handoff refers to all versions of Soft Handoff including Softer Handoff, Soft-soft Handoff, Soft-softer Handoff and 3 or more legs in a Soft Handoff.

Glossary of Terms

| | |
|---|---|
| AMPS | Advanced Mobile Phone System |
| CDMA | Code Division Multiple Access |
| GSM | Global System for Mobile Communication |
| HLR | Home Location Register |
| LA | Location area |
| MOA | Mobility Area |
| PN | Pseudorandom Noise |
| QoS | Quality of Service |
| TDMA | Time Division Multiple Access |
| UMTS | Universal Mobile Telecommunication Service |
| WLL | Wireless Local Loop |

### Limiting Mobility in a Cell

To limit mobility in a cell each subscriber (handset) is associated with a pre-defined cell or cells. This is referred to here as the “Home Cell Set”. Home-cell information becomes part of the subscription data of the handset which is stored in the HLR. Home-cell information may also be stored in the handset if mobility restrictions are to be enforced by the handset call processing.

In CDMA systems the Home-cell is identified by a single PN Offset. Each subscriber handset is then associated with a single PN Offset, which is its Home-cell.

A subscriber handset can make or receive calls only if the received signal from the home-cell is above a pre-defined level and the home-cell has enough capacity to support the call from the handset. In CDMA systems it could imply that Ec/Io of the home-cell is above a pre-defined threshold for communication and capacity limits for forward and reverse link have not been exhausted.

Once a call is established the signal from the home-cell on the forward link and the signal from the handset to the home-cell on the reverse link must remain above specified thresholds for viable communication. If at any time during the call home-cell signal fades below the threshold or if the reverse link signal becomes weak the call is disconnected for lack of service.

A variation in this could allow a pre-established call to complete before denying service to the handset. From start to the completion of the call no other restrictions are imposed, which means that the handset can perform all types of handoffs including Soft Handoff. The system performance therefore, does not degrade.

Denial of service to the handset could be initiated in either of the following ways:

### At Call Origination/Termination

At the time of call origination or call termination if at least one cell in the Home-Cell set does not have good signal quality above a specified threshold on forward or reverse link or if it does not have enough capacity either on the forward or reverse link the handset is denied service. This could be done either by the subscriber terminal (if it is so programmed) or by the network.
By the Subscriber Terminal: At the time of call origination or termination the subscriber terminal (handset) measures the signal strength of the cells through which it can communicate (the active cell set). If the signal strength of the at least one Home-cell is not above a threshold (Ec/Io could be the criteria for CDMA) the handset disables all call handling functions except for origination or termination of emergency calls.
By the Network: At the time of call origination/termination if the mobile measured forward link (downlink) signal strength of the Home-cell is below the required threshold or if the received signal strength at the Home-cell is not sufficient or if the Home-cell does not have enough capacity to support any more calls, the handset is denied service by the network.

### During Already Established Call

If a call has been already established and the handset goes out of the coverage of the Home-cell set the call may be disconnected. This disconnection could be performed by the handset or by the network.
By the Subscriber Terminal: The handset measures the received signal of the home-cells in the home cell set or gets the information on the quality of the reverse link form the base station and establishes that the service needs to be disconnected. At this point the handset disables its call processing functions. In CDMA or wideband systems this decision could be based upon the Ec/Io measurement performed by the handset.
By the Network: The network establishes that the signal received by handset from the home-cell or the signal received by the base station from the handset has become weak in terms of signal strength or signal to interference ratio or any other criteria. At this point the network denies service to the handset. In CDMA systems, for example, an implementation could be to monitor the Active Set of PN-Offsets for the handset. At any time during normal call processing if an active set is formed that does not have the home-cell in it the service is denied to the handset.

It may be noted here that the definition of denial of service could be defined by the network operator to mean restrictions on call originations only or call terminations only or both origination and terminations.

### Limiting Mobility in a Cell-Site

A variation of the above method can be used to restrict mobility in a larger area covered by a cell-site that could be composed of one cell (an omni-directional site) or may be composed of two or more cells. In this case a handset is associated with a cell-site, which is its home-cell-site. All cells of that cell-site are then home-cells of the handset. All these home-cells (the “home cell set”) are listed in the subscription data of the handset (subscriber) and may also be stored in the handset for mobility restrictions. In a CDMA system the Home Cell site of a subscriber may be identified by a set of PN Offsets which belong to the various cells of the cell-site. These PN Offsets will form the Home-cell Set of the subscriber. Each subscriber will have a predefined Home-cell set. For limiting mobility in a cell-site the procedure is the same as specified for single Home-cell. Only difference is that now the handset is denied service when not even a single cell in its Home-cell Set is above the pre-defined thresholds for establishing and maintaining a call.

### Limiting Mobility in a Region

A region could be specified that has more then one cell-site or more than one cells that belong to the same or different cell-sites. This region becomes the home-region of the handset. Cell-sites in this region become home-cell-sites and all cells become Home-cells for the handset. This information is stored by the network in the subscriber data for the handset and may also be stored in the handset for mobility restrictions. Home-cell Set is defined for each subscriber. In CDMA systems the Home-cell Set includes PN Offsets of all cells that are in the Home-region of the mobile. Mobile is allowed to make and receive calls or get service till the time at-least one of its Home-cells has strong enough signal to be above a pre-defined threshold. The rest of the process works the same as defined for single cell. It may be noted here that for CDMA various types of User Zones, as described in the CDMA standard could be used to define regions of service for the subscriber. Normally these User Zones are geography based. Thus, all PN Offsets that are within the area covered by the User Zone will form the Home-cell set of the subscriber who is allotted that particular User Zone. Home-region, thus, could be understood to be a PN Offset based User Zone definition.

### Cluster Based Mobility Restriction: A Variation for CDMA

In CDMA systems a slight variation of this method could be implemented at the cost of Quality of Service (QoS). This variation is called Cluster Based Mobility for handset. The handset in this method is allowed mobility, anywhere; however, it can have only the PN Off-set of the cells in its active set that are part of a pre-defined cluster of cell-sites. The home cluster is defined for each mobile. In this method if the handset receives a strong signal from a cell outside of the pre-defined cluster the handset will not be allowed to communicate or do soft Handoff with it. As compared to the method described earlier the Cluster Based Variation provides lesser quality of service.

### Implementation of the Limited Mobility Technique in CDMA Systems

Implementation of the above described technique in CDMA systems would require that each subscriber is assigned a set of PN Offsets that form the Home-cell set for the handset. The Home-cell Set may only have one PN Offset in which case a single cell mobility restriction would be imposed. If the Home-cell Set has PN offsets of sectors of the same cell-site a single cell-site mobility restriction will be imposed, similarly region based mobility restriction can be imposed by having PN Offsets from multiple sites in the Home-cell set of a particular subscriber. Home-cell set information is stored in the network as subscriber data. When a handset tries to originate or receive a call it must do so using at least one of the cells in its home-cell set. If none of the cells in the Home-cell Set of the handset can provide service to the handset due to signal quality or lack of capacity the handset is denied service either by the network or by the handset call processing functions. During call processing the Active set (set of PN Offsets with which a handset is simultaneously communicating) of the handset is closely monitored. If at any time due to signal strength or other reasons an active set is formed or about to be formed that does not have at least one PN Offset from the subscribers Home-cell Set the call is disconnected. A variation in this technique could allow a call to continue under these circumstances if the call started in an area where one of the Home-cells was available.

### Example of Single Cell Mobility Restriction Implementation in CDMA

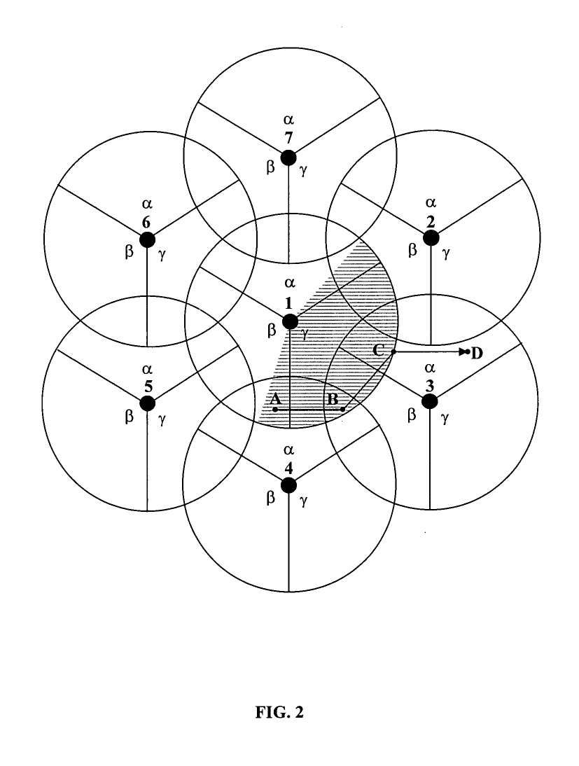

Consider a CDMA system that has a number of cell-sites out of which a cluster of seven cell-sites is shown in FIG. 2. This system imposes a Single Cell Mobility restriction using the technique described above. Consider that a subscriber in the system is associated with cell 1(γ) as shown in FIG. 2. Thus, the Home-cell Set of the subscriber consists of 1(γ) only.
Handset Home-cell Set: 1(γ)

Assume that the subscriber moves from Point A to Point D via B and C. At these points the system will handle the calls of the subscriber as follows.
Point A: The handset is able to originate and receive calls because it is in the coverage area of its Home-sector 1(β) and that cell has enough capacity to support new calls. CDMA Handset Active Set at this point consists of 1(γ), 1(β) and 4(α).
Handset Active Set: 1(γ), 1(β) and 4(α)
Point B: The handset is able to continue an already established call and can also originate and receive calls at this point because it is in the coverage of its Home-cell. CDMA Handset Active Set at this point consists of 1(γ), 4(α) and 3(β).
Handset Active Set: 1(γ), 4(α) and 3(β)
Point C: The handset is able to continue an already established call and can also originate and receive calls at this point because it is in the coverage of its Home-cell. CDMA Handset Active Set at this point consists of 1(γ) and 3 (α).

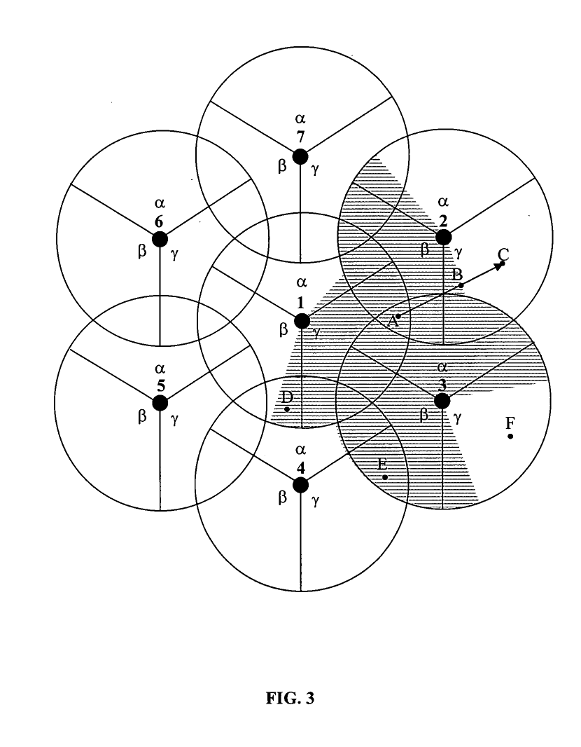

Handset Active Set: 1(γ) and 3 (α)
Point D: The handset may be allowed to continue an already established call as it moves from Point C to Point D, however, when at Point D it cannot originate or receive calls as it is not within the coverage of its Home Cell.
Handset Active Set: Empty (if earlier established calls are not allowed to carry)
   Handset Active Set: 3(α) and 3(γ) (if earlier established calls are allowed to carry even when Home-cell Set is not available)
Example of Region Based Mobility Restriction Implementation in CDMA
A region for restricting mobility could be defined by two or more PN Offsets belonging to two or more cells. These cells could be from the same cell-site or from different cell-sites. FIG. 3 shows an example where four cells from three different cell-sites define a region in which mobility is allowed to a subscriber. Thus, in this case, the size of the Home-cell set is four and it consists of 1(γ), 2(β), 3(α) and 3(β).
   Handset Home-cell Set: 1(γ), 2(β), 3(α) and 3(β)
As the subscriber moves from Point A to Point C in FIG. 3 and when it is located at Points D, E and F the system handles subscriber calls as follows.
Point A: Handset is able to originate or terminate a call because 2(β), 1(α) and 3(α) all have a strong signal and they are in the Home-cell set of the handset. 1(γ) does not have enough capacity to support handoffs but 2(β) and 3(α) can service the call. CDMA Handset Active Set at this point consists of 2(β) and 3(α).
   Handset Active Set: 2(β) and 3(α)
Point B: After a call has been setup at Point A the handset starts to move towards Point B. At Point B the Handset is provided service because it is within the coverage of 2(β) which is in the Home-cell set of the handset. CDMA Handset Active Set at this point consists of 2(β) and 2(γ).
   Handset Active Set: 2(β) and 2(γ)
Point C: As the handset moves beyond Point B none of Cells it is receiving are included in the Home-cell set of the handset. At this point the service is denied to the handset, however, if a call is already setup it may be allowed to continue until its completion. The active set at that point will have 2(γ). However, if this call is dropped or completed the subscriber will not be able to originate or receive another call.
Handset Active Set: Empty (if earlier established calls are not allowed to carry)
   Handset Active Set: 2(γ) (if earlier established calls are allowed to carry even when Home-cell Set is not available)
Point D: At this point the handset is allowed to originate and terminate (receive) calls because it is within the coverage area of 1(γ) which is in its Home-cell Set.
Handset Active Set: 1(α), 1(β) and 4(α)
Point C & F: Handset cannot originate or terminate a call because none of the cells in its Home-cell set are being received at this point.

Although these examples have been stated in terms of CDMA wireless systems, it will be understood that the method of the invention is usable with other wireless systems such as AMPS, TDMA, GSM, CDMA, UMTS, 2G, 3G, 4G, WAN, WiFi, and OFDM, and other systems known today or yet to be developed.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method for restricting service to terminal equipment of a wireless subscriber in a wireless communication system, to a home set of cells, comprising the steps of:
a) associating a home cell set to a subscriber;
b) during call processing allowing handoffs and comparing an active set of cells, through which the terminal equipment is communicating, with the home cell set of the subscriber;
c) denying service to the subscriber when the active set does not have at least one cell from the home cell set of the subscriber.

2. The method of claim 1 in which home cell set information is stored in the wireless communication system as subscription information for the subscriber.

3. The method of claim 1 in which home cell set information is stored in the terminal equipment of a subscriber.

4. The method of claim 1 in which wireless communication system is of the type selected from a group comprising AMPS, TDMA, GSM, CDMA, UMTS, 2G, 3G, 4G, WAN, WiFi, and OFDM.

5. The method of claim 1 in which the home cell set consists of a plurality of cells belonging to a plurality of cell-sites.

6. The method of claim 1 in which wireless communication system is CDMA based and the home cell set is defined using PN Offsets.

7. The method of claim 1 in which step (c) of denying service is performed by restricting call originations from the subscriber's terminal equipment.

8. The method of claim 7 in which step (c) of denying service is also performed by restricting call terminations to the subscriber's terminal equipment.

9. The method of claim 1 in which the step (c) of denying service is performed at the time of call origination and call termination if the active set does not have at least one cell from the home cell set.

10. The method of claim 1 in which step (c) of denying service is performed by restricting a subscriber from originating a new call, but if a call has been established while the terminal equipment is in the home cell set, allowing the call to continue.

11. The method of claim 1, in which step (c) of denying service is performed by a server in the wireless communication system.

12. The method of claim 1, in which step (c) of denying service is performed by the subscriber's terminal equipment.

13. The method of claim 1 in which the wireless communication system is CDMA based and soft handoff is allowed with a plurality of cells in the wireless communication system.

14. The method of claim 1 in which the wireless communication system is CDMA based and soft handoff is restricted to cells that belong to a cluster of cell-sites specified for the subscriber.

15. The method of claim 1 in which emergency calls are allowed for a subscriber even when the terminal equipment is outside coverage of the home cell set.

16. The method of claim 1 in which the home cell set includes less than all cells from at least one cell-site having a plurality of cells.
